(19) United States
(12) Patent Application Publication
(10) Pub. No.: US 2007/0201890 A1
(43) Pub. Date: Aug. 30, 2007

(54) Fusing system of image forming apparatus and method for controlling thereof

(75) Inventor: Chul-woo Oh, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/521,408

(22) Filed: Sep. 15, 2006

(30) Foreign Application Priority Data
Feb. 24, 2006 (KR) 2006-18324

(51) Int. Cl. G03G 15/20

(52) U.S. Cl. 399/67

(57) ABSTRACT

A fusing system and a fusing control method of an image forming apparatus includes a sensor which senses whether a skew of a paper is generated, wherein the skew refers to the paper being obliquely fed along a paper feeding path, a fusing unit which fuses a developer transferred on the paper, and a controller, if it is sensed that the skew is generated, which controls fusing operations of the fusing unit not to performed. The heater lamp is controlled depending on whether a paper skew is generated while the paper is fed so that power and toner waste can be reduced for a paper that loses the value of printing result.

### CROSS-REFERENCE TO RELATED APPLICATIONS

This application claims the benefit under 35 U.S.C. § 119 (a) of Korean Patent Application No. 2006-18324 filed on Feb. 24, 2006, in the Korean Intellectual Property Office, the disclosure of which is hereby incorporated by reference.

### BACKGROUND OF THE INVENTION

1. Field of the Invention

Aspects of the present invention relate to a fusing system of an image forming apparatus and a controlling method thereof. More particularly, aspects of the present invention relate to a fusing system of an image forming apparatus that controls a heater lamp depending on whether a skew of a paper is generated during a paper feeding process, and a control method thereof.

2. Description of the Related Art

An image forming apparatus prints an image corresponding to original image data on a recording medium such as paper, transparency, etc. Different types of image forming apparatuses include, for example, a printer, a copier, and a facsimile machine. Image forming apparatuses, such as a laser beam printer, a light emitting diode (LED) print head (LPH) printer, and a facsimile machine, all employ an electro-photographic scheme.

An image forming apparatus employing a general electro-photographic scheme performs printing onto the recording medium through the following processes: a charging process which charges a photosensitive drum with a charging roller in order to form a regular potential on the photosensitive drum; a light exposing process which scans the charged photosensitive drum through a laser scanning unit (LSU) with a light beam to form an electro-static latent image; a developing process which develops the electro-static latent image formed on the photosensitive drum with a developer; a transfer process which transfers a visible image formed on the photosensitive drum through a transfer roller onto a recording medium; and finally, a fusing process which heats and presses the developer transferred onto the recording medium, with a predetermined heat and pressure to fuse it onto the recording medium.

FIG. 1 is a view schematically illustrating a fusing system of an image forming apparatus employing a conventional electro-photographic scheme.

Referring to FIG. 1, the conventional fusing system includes a fusing unit 10, thermistor 16, a power supply 20, and a controller 30.

The fusing unit 10 includes a fusing roller 12 employing a heater lamp 12a as a heating source, and a press roller 14 that rotates in contact with the fusing roller 12 and presses and fuses an image transferred onto the recording medium. The fusing roller 12 is heated by the heater lamp 12a which emits heat using power supplied from a power supply 20.

The visible image, which is formed on the recording medium by a transfer process, passes between the fusing roller 12 and the pressure roller 14 and is pressed and heated by a predetermined heat and pressure.

The thermistor 16 is formed on an outside of the fusing roller 12 to sense a surface temperature of the fusing roller 12 heated by the heater lamp 12a. The thermistor 16 senses the surface temperature of the fusing roller 12, and transmits this surface temperature to the controller 30.

The controller 30 controls a power supplied to the heater lamp 12a based on the surface temperature of the fusing roller 12, which is sensed by the thermistor 16. Specifically, the controller 30 compares the temperature sensed by the thermistor 16 with a pre-set reference temperature to control power supplied to the heater lamp 12a.

However, a paper skew may occur while a paper is fed to an image forming apparatus. If a skew occurs, paper edges and printing contents are not aligned properly due to deviation, causing the value of the print to be lost and the quality of the print to deteriorate. Thus, when a skew occurs, the developing, transfer, and fusing processes are performed on the skewed paper, and consequently, toner and power may be wasted. Therefore, there is a need to decrease the substantial power waste caused by unnecessary printing to paper which is skewed.

### SUMMARY OF THE INVENTION

Accordingly, aspects of the present invention solve at least the above and/or other problem and/or disadvantages and provide at least the advantages described below. Therefore, an aspect of the present invention is to provide a fusing system of an image forming apparatus that controls a heater lamp depending on whether a paper skew is generated while a paper is fed, and a control method thereof.

According to one aspect of the present invention, there is provided a fusing system of an image forming apparatus, the system including a sensor which senses whether a skew of a paper is generated, wherein the skew refers to the paper being obliquely fed along a paper feeding path, a fusing unit which fuses a developer transferred on the paper, and a controller, if it is sensed that the skew is generated, which controls fusing operations of the fusing unit.

The fusing system may further include a heater lamp which is provided in a fusing roller of the fusing unit to heat the fusing roller. If the skew is generated, the controller turns the heater lamp off, and accordingly, the fusing operations of the fusing unit are not performed.

The fusing system may further include a laser scanning unit (LSU) which emits a laser beam onto a photosensitive medium to form an electro-static latent image. If the skew is generated, the controller prevents the LSU from forming the electro-static latent image on a surface of the photosensitive medium.

The fusing system may further include a transfer unit which transfers an image developed by the developer onto the paper, and a detector which detects a voltage of the transfer unit, determines whether the detected voltage of the transfer unit is included in a predetermined reference voltage range of the transfer unit, and transmits a detection result signal according to the determination result to the controller. If the detection result signal received from the detector indicates that the detected voltage is abnormal, the controller turns off the heater lamp, and accordingly, the fusing operations of the fusing unit are not performed.

If the detected voltage of the transfer unit does not fall within the predetermined reference voltage range of the transfer unit, the detector determines that the voltage is abnormal. If the detected voltage of the transfer unit falls within the predetermined reference voltage range of the transfer unit, the detector determines that the voltage is normal, and transmits the detection result signal, including the determination result, to the controller.

The fusing system may further include a fusing unit sensor which calculates a fusing time required to pass the paper from an entrance side to an exit side of the fusing unit, and transmits the fusing time to the controller. If the detection result signal received from the detector indicates that the detected voltage of the transfer unit is normal, the controller compares a predetermined reference fusing time with the fusing time received from the fusing unit sensor. If the fusing time is greater than the reference fusing time, the controller transmits a message or a warning LED to a user, which notifies the user that a temperature of the fusing unit needs to be checked.

The reference fusing time refers to the amount of time required to pass the paper from an entrance side to an exit side of the fusing unit, and is pre-set depending on product models of the image forming apparatus.

If the detection result signal received from the detector notifies the user that the detected voltage is abnormal, the controller turns off the heater lamp, and accordingly, the fusing operations of the fusing unit are not performed.

The fusing system may further include a fusing unit sensor which calculates a fusing time required to pass the paper from an entrance side to an exit side of the fusing unit, and transmits the calculated fusing time to the controller. The controller compares a predetermined reference fusing time with the fusing time and if the fusing time is greater than the reference fusing time, the controller transmits a message or a warning LED, which notifies the user that a temperature of the fusing unit needs to be checked.

According to an aspect of the present invention, there is provided a fusing control method of an image forming apparatus, the method including sensing whether a skew of a paper is generated, wherein the skew refers to paper which is obliquely fed into the image forming apparatus, and if the skew is generated, preventing fusing operations of the fusing unit, which fuse a developer transferred on the paper, from being performed.

If the skew is generated, the operation of controlling may turn off the heater lamp, which is provided in a fusing roller of the fusing unit to heat the fusing roller, and accordingly, the fusing operations of the fusing unit are not performed.

If the skew is generated, the operation of controlling may also include preventing an LSU, which emits a laser beam onto a photosensitive medium to form an electro-static latent image, from forming the electro-static latent image on a surface of the photosensitive medium.

The method may further include detecting a voltage of the transfer unit, which transfers an image developed by the developer onto the paper, determining whether the detected voltage of the transfer unit is included in a predetermined reference voltage range of the transfer unit, and outputting a detection result signal according to the determination result. If the detection result signal notifies the user that the detected voltage is abnormal, the operation of controlling turns off the heater lamp off, and accordingly, the fusing operations of the fusing unit are not performed.

If the detected voltage of the transfer unit does not fall within the predetermined reference voltage range of the transfer unit, the operation of outputting the detection result signal determines that the voltage is abnormal, and if the detected voltage of the transfer unit falls within the predetermined reference voltage range of the transfer unit, the operation determines that the voltage is normal, and outputs the detection result signal including the determination result.

The method may further include calculating a fusing time required to pass the paper from an entrance side to an exit side of the fusing unit, and transmitting the calculated fusing time to a controller. If the detection result signal indicates that the detected voltage is normal, the operation of controlling compares a predetermined reference fusing time with the fusing time and if the fusing time is greater than the reference fusing time, the operation transmits a message or a warning LED, which notifies the user that a temperature of the fusing unit needs to be checked.

If the detection result signal notifies the user that the voltage is abnormal, the operation of controlling turns off the heater lamp, which heats the fusing roller, and accordingly, the fusing operations of the fusing unit are not performed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view schematically illustrating a fusing system of a conventional image forming apparatus;

FIG. 2 is a view schematically illustrating a structure of an image forming apparatus according to an embodiment of the present invention;

FIG. 3 is a view schematically illustrating a fusing system of the image forming apparatus illustrated in FIG. 2; and

FIG. 4 is a flowchart for explaining operations of a fusing system of the image forming apparatus illustrated in FIG. 3.

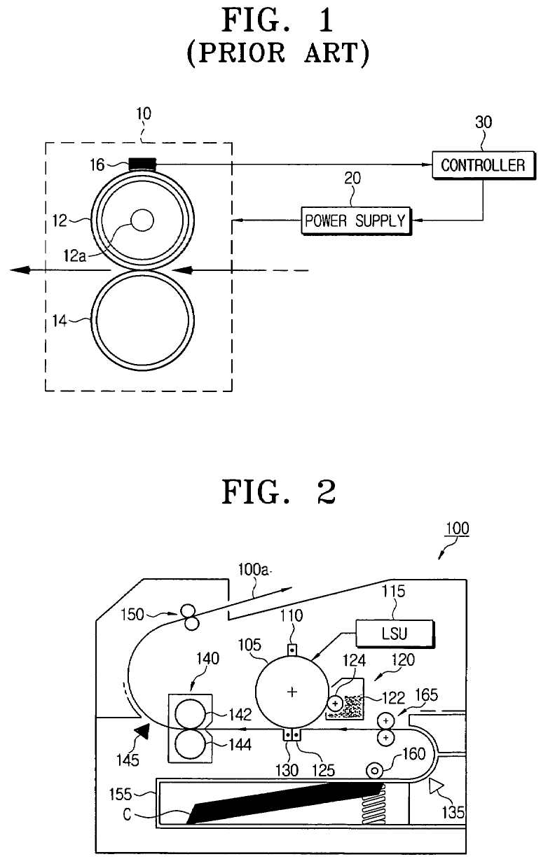

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is a view schematically illustrating a structure of an image forming apparatus according to an embodiment of the present invention.

Referring to FIG. 2, an image forming apparatus 100 includes a photosensitive drum 105, a charging unit 110, a laser scanning unit 115, a developing unit 120, a transfer unit 125, and a fusing unit 140.

The photosensitive drum 105 is charged by a charge voltage such as −1400 V applied to the charging unit 110. Specifically, the surface of the charging unit 110 is charged by a charge voltage applied to the charging unit 110, and then the surface of the photosensitive drum 105 is charged by the rotation of the photosensitive drum 105. Accordingly, a constant potential is formed on the surface of the photosensitive drum 105.

A laser scanning unit (LSU) 115 emits a laser beam corresponding to print data onto the surface of the photosensitive drum 105 that is constantly charged by the charge voltage. Accordingly, an electro-static latent image is formed on the surface of the photosensitive drum 105. Here, the print data is transmitted from a print data generating device, such as a host computer (not shown), which is connected to the image forming apparatus 100 and communicates with the image forming apparatus 100.

The developing unit 120 develops the electro-static latent image formed on the photosensitive drum 105 with a developer, such as a toner. Specifically, the developer supplied from a developer supply 122 is friction-charged by the developing roller 124 and moved to a developing area, and the developer moved to the developing area is again moved and adhered to a light exposure area on the photosensitive drum 105 by a potential difference between a light exposure potential of the photosensitive drum 105 and a developing potential of the developing roller 124. According to this process, a toner image is developed.

The transfer unit 125 transfers the developer, which is adhered to the photosensitive drum 105 through the developing process, onto a printing paper C. This printing paper C may be instead be any other type of recording medium, and is not limited to being paper. Specifically, rotating the transfer unit 125 meshed with the photosensitive drum 105 allows the toner image formed on the photosensitive drum 105 to be transferred onto the printing paper C. The printing paper C becomes in close contact with the photosensitive drum 105 by an electrostatic force.

A separator 130 separates the printing paper C from the photosensitive drum 105.

The fusing unit 140 includes a fusing roller 142 and a press roller 144. The developer transferred to the printing paper C passes through the fusing roller 142 and the press roller 144 of the fusing unit 140 and is fixed on the printing paper C. Then, the printing paper C is discharged to the outside by a discharge roller 150, and consequently, a printing work for a desired image is completed.

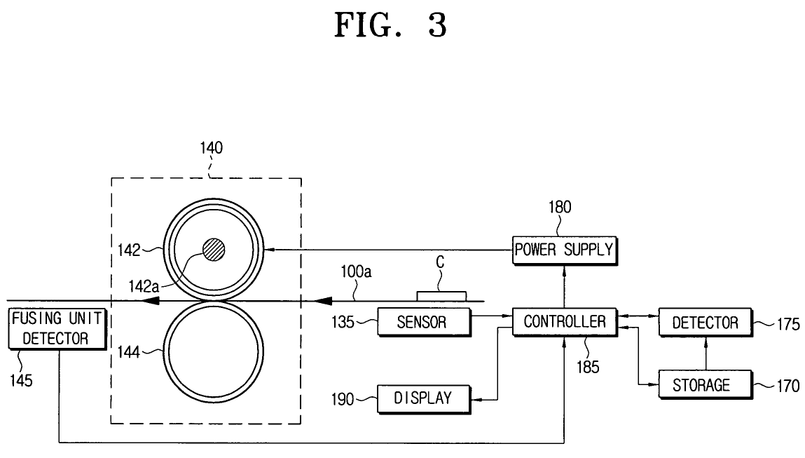

FIG. 3 is a schematic view of a fusing system of an image forming apparatus, which is illustrated in FIG. 2.

Referring to FIGS. 2 and 3, the fusing system includes a sensor 135, a storage unit 170, a detector 175, a power supply 180, a controller 185, a display 190, and a fusing unit sensor 145.

The sensor 135 detects whether the printing paper C, which is loaded in the paper cassette 155, is fed to the pick-up roller 160, and senses whether a skew of the printing paper C, which is created by the pick-up roller 160, is generated. When a skew of the printing paper C is generated, the sensor 135 transmits a skew generation signal to a controller 185, which will be explained later. The skew of the printing paper C refers to the printing paper C being obliquely fed along a paper feeding path 100a by a feeding roller 165, as a result of the pick-up roller 160.

The storage unit 170 stores a control program to implement and control operations of the image forming apparatus 100 according to an embodiment of the present invention, and stores a reference voltage range and a reference fusing time of the transfer unit 125. The reference voltage range of the transfer unit 125 is pre-set as a predetermined limit voltage range necessary for driving the transfer unit 125. The reference fusing time is pre-set depending on product models of the image forming apparatus 100, and refers to the time required to pass printing paper C from an entrance side to an exit side of the fusing unit 140.

The detector 175 measures voltage of the transfer unit 125 and determines, referring to the storage unit 170, whether the measured voltage of the transfer unit 125 falls within the reference voltage range of the transfer unit 125. The detector 175 transmits a detection result signal to the controller 185, which will be explained later. The detection result signal includes information on whether the measured voltage of the transfer unit 125 is normal or abnormal depending on the determination result. In other words, when the measured voltage of the transfer unit 125 does not fall within the reference voltage range of the transfer unit 125, the detector 175 determines that the voltage of the transfer unit 125 is abnormal due to a high voltage inferiority, and when the measured voltage of the transfer unit 125 falls within the reference voltage range of the transfer unit 125, the detector 175 determines that the voltage of the transfer unit 125 is normal. At this time, the detector 175 transmits a detection result signal including the determination result to the controller 185, which will be explained later.

The power supply 180 applies predetermined voltages to the photosensitive drum 105, the charge unit 110, the developing unit 120, the transfer unit 125, and the fusing unit 140, respectively, under the control of the controller 185.

The fusing unit 140 comprises the fusing roller 142 and the press roller 144.

The fusing roller 142 is configured in multiple layers, such as two layers or three layers, and employs therein a heater lamp 142a as a heating source. The heater lamp 142a may include a halogen lamp. The fusing roller 142 is heated by the heater lamp 142a that emits heat by alternating current electricity supplied from the power supply 180.

The press roller 144 rotates in contact with the fusing roller 142, and allows the printing paper C to be in close contact with the fusing roller 142. The press roller 144 is elastically supported by a spring device (not shown) and presses the printing paper C, which passes between the fusing roller 142 and the press roller 144, with a predetermined pressure toward the fusing roller 142.

The fusing unit sensor 145 calculates the fusing time that is required to pass the printing paper C from the entrance side to the exit side of the fusing unit 142, and transmits the calculated fusing time to the controller 185, which will be explained later. The fusing unit sensor 145 calculates the number of fusing papers, which is the number of printing papers C passing through the fusing unit once the print command is given, and transmits the calculated number of fusing papers to the controller 185.

When the sensor 135 senses the skew of the printing paper C, the controller 185 controls the power supply 180 to block the power to the fusing unit 140, and prevents the laser scanning unit 115 from emitting a laser beam. Specifically, when the skew generating signal of the printing paper C is received from the sensor 135, the controller 185 controls the power supply 180 to turn off the heater lamp 142a, which is a heating source of the fusing roller 142, and prevents the laser scanning unit 115 from forming an electrostatic latent image on the photosensitive drum 105.

If the detection result signal received from the detector 175 indicates that the voltage of the transfer unit 125 is abnormal, the controller 185 controls the power supply 180 to block the power to the fusing unit 140. In detail, the controller 185 controls the power supply 180 to turn off the heater lamp 142a so that fusing operations of the fusing unit 140 are not performed.

If the detection result signal received from the detector 175 indicates that the voltage of the transfer unit 125 is normal, the controller 185 compares the reference fusing time with the fusing time received from the fusing unit sensor 145, referring to the storage unit 170. In this case, if the received fusing time is greater than the reference fusing time, the controller 185 controls the display 190 to display a message or a warning LED, which notifies a user that the temperature of the fusing unit 140 needs to be checked.

The controller 185 compares the number of the fusing papers received from the fusing unit sensor 145 with the number of papers requested to be printed, and if the number of papers matches, the controller 185 completes processing of the printing work in response to the print request. The number of papers requested to be printed refers to the number of printing papers (for example, 10 sheets) that are requested to be printed by a user.

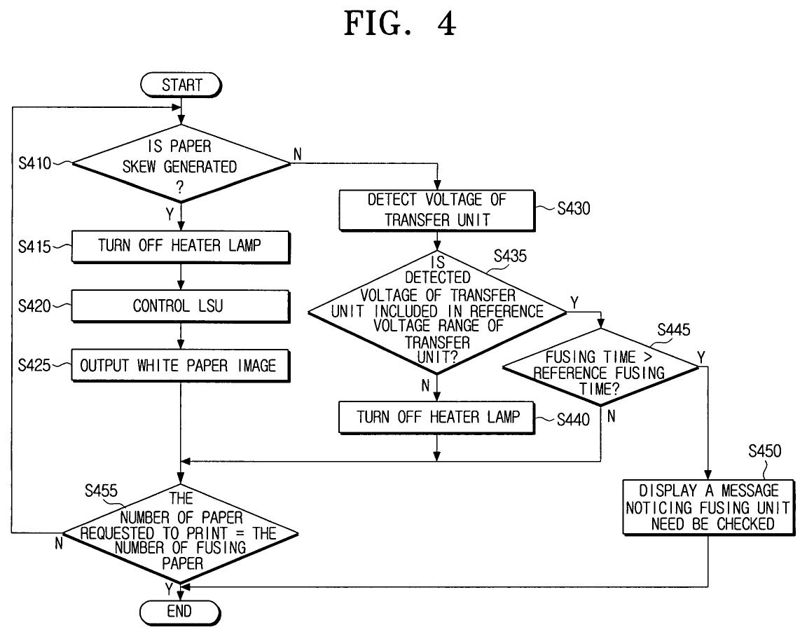

FIG. 4 is a flowchart for explaining operations of a fusing system of the image forming apparatus illustrated in FIG. 3.

Referring to FIGS. 3 and 4, the sensor 135 senses whether a skew of the printing paper C, supplied from the paper cassette 115 by the pick-up roller 160, is generated, and if the skew generation is sensed, the sensor 135 transmits a skew generation signal to the controller 185 (S410). The skew of the printing paper C refers to the printing paper C, which is supplied by the pick-up roller 160, is obliquely fed along the paper feeding path 100a by the feeding roller 165.

The controller 185, which receives the skew generation signal, controls the power supply 180 to turn off the heater lamp 142a (S415). Accordingly, the controller turns off the heater lamp 142a so that the fusing unit 140 having the heater lamp 142a does not perform fusing operations.

The controller 185 also controls the emission of laser beams from the laser scanning unit 125 (S420).

If the skew of the printing paper C is generated in the operations S415 and S420, the controller 185 controls the power supply 180 in such a way to turn off the heater lamp 142a that is a heating source of the fusing roller 142, and also prevents the laser scanning unit 115 from forming an electrostatic latent image on the photosensitive drum 105, so that a white paper image can be output (S425). The white paper image refers to an image where developer has not been transferred onto the printing paper C.

If the skew of the printing paper C is not sensed in operation S410, the detector 175 measures the voltage of the transfer unit 125 (S430).

The detector 175 determines whether the measured voltage of the transfer unit 125 is included in the predetermined reference voltage range of the transfer unit 125, and transmits detection result signals depending on the determination result to the controller 185 (S435). Specifically, when the measured voltage of the transfer unit 125 does not fall within the reference voltage range of the transfer unit 125, the detector 175 determines that the voltage of the transfer unit 125 is abnormal, and when the measured voltage of the transfer unit 125 does fall within the reference voltage range of the transfer unit 125, the detector 175 determines that the voltage of the transfer unit 125 is normal. At this time, the detector 175 transmits a detection result signal including the determination result to the controller 185.

If the received detection result signal indicates that the voltage of the transfer unit 125 is abnormal, the controller 185 controls the power supply 180 to turn off the heater lamp 142a (S440). In other words, if the voltage of the transfer unit 125 measured in the operation S430 does not fall within the predetermined reference voltage range of the transfer unit 125, the controller 185 controls the power supply 180 to turn off the heater lamp 142a. Therefore, the fusing unit 140 having the heater lamp 142a does not perform fusing operations.

If the received detection result signal notifies that the voltage of the transfer unit 125 is normal, the controller 185 compares the predetermined reference fusing time with the fusing time received from the fusing unit sensor 145 (S445). The fusing time refers to the time required to pass the printing paper C from an entrance side to an exit side of the fusing unit 142. The reference fusing time is pre-set depending on product models of the image forming apparatus 100, and refers to the time required to pass printing paper C from an entrance side to an exit side of the fusing unit 140.

If the fusing time is greater than the reference fusing time, the controller 185 controls the display 190 to display a message or a warning LED, which notifies a user that the temperature of the fusing unit 140 needs to be checked.

Specifically, if the temperature of the fusing unit 140 is in excess of the predetermined reference temperature, the fusing unit 140 is overheated and the printing paper C is adhered to the fusing unit 140 so that the fusing time of the printing paper C becomes in excess of the reference fusing time. At this point, the controller 185 controls the display 190 to display a message or a warning LED that the fusing unit 140 needs to be checked in order to notify a user of the abnormal temperature of the fusing unit 140.

The controller 185 compares the number of the fusing papers received from the fusing unit sensor 145 with the number of papers requested to be printed by the user, and if the number of papers matches, the controller 185 completes processing the printing work, in response to the print request (S455). In other words, the operations S410 through S450 are repeatedly performed for every printing paper C until the number of the fusing papers and the number of the papers requested to print are identical. The number of papers requested to be printed refers to the number of printing papers (for example, 10 sheets) that are requested by a user.

As described above, according to embodiments of the present invention, a heater lamp of a fusing unit is controlled depending on whether a paper skew is generated while paper is fed onto a paper feeding path. Therefore, power and toner waste can be reduced for paper that loses the value of printing results.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fusing system of an image forming apparatus, the fusing system comprising:
a sensor which senses whether a skew of a paper is generated, wherein the skew refers to the paper being obliquely fed along a paper feeding path;
a fusing unit which fuses a developer transferred onto the paper; and
a controller, wherein the controller turns off fusing operations of the fusing unit if the sensor senses that the skew is generated.

2. The fusing system as claimed in claim 1, further comprising:
a heater lamp which is provided in a fusing roller of the fusing unit to heat the fusing roller, wherein the controller turns off the heater lamp, and accordingly, turns off the fusing operations of the fusing unit, if the sensor senses that the skew is generated.

3. The fusing system as claimed in claim 1, further comprising:
a laser scanning unit (LSU) which emits a laser beam onto a photosensitive medium to form an electro-static latent image, wherein the controller prevents the LSU from forming the electro-static latent image on a surface of the photosensitive medium, if the sensor senses that the skew is generated.

4. The fusing system as claimed in claim 1, further comprising:
a transfer unit which transfers an image developed by the developer onto the paper; and
a detector which detects a voltage of the transfer unit, determines whether the detected voltage of the transfer unit falls within a predetermined reference voltage range of the transfer unit, and transmits a detection result signal according to a determination result to the controller, wherein the controller turns off the heater lamp, and accordingly, turns off the fusing operations of the fusing unit, if the detection result signal received from the detector indicates that the voltage of the transfer unit does not fall within the predetermined reference voltage range.

5. The fusing system as claimed in claim 4, wherein if the voltage of the transfer unit does not fall within the predetermined reference voltage range of the transfer unit, the detector determines that the voltage of the transfer unit is abnormal, and if the voltage of the transfer unit does fall within the predetermined reference voltage range of the transfer unit, the detector determines that the voltage of the transfer unit is normal, and transmits the detection result signal including the determination result to the controller.

6. The fusing system as claimed in claim 4, further comprising:
a fusing unit sensor which calculates a fusing time required to pass the paper from an entrance side to an exit side of the fusing unit and transmits the calculated fusing time to the controller, wherein, if the detection result signal received from the detector indicates that the voltage of the transfer unit falls within the predetermined reference voltage range, the controller compares a predetermined reference fusing time with a fusing time received from the fusing unit sensor, and if the fusing time received from the fusing unit sensor is greater than the reference fusing time, the controller transmits a message or a warning to a user indicating that a temperature of the fusing unit needs to be checked.

7. The fusing system as claimed in claim 6, wherein the reference fusing time refers to a time required to pass the paper from the entrance side to the exit side of the fusing unit, and is pre-set depending on product models of the image forming apparatus.

8. The fusing system as claimed in claim 4, wherein if the detection result signal received from the detector indicates that the detected voltage falls within the predetermined reference voltage range, the controller turns off the heater lamp, and accordingly, turns off the fusing operations of the fusing unit.

9. The fusing system as claimed in claim 1, further comprising:
a fusing unit sensor which calculates a fusing time required to pass the paper from an entrance side to an exit side of the fusing unit, and transmits the calculated fusing time to the controller wherein the controller compares a predetermined reference fusing time with the calculated fusing time, and if the calculated fusing time is greater than the reference fusing time, the controller transmits a message or a warning to a user indicating that a temperature of the fusing unit needs to be checked.

10. A fusing control method of an image forming apparatus, the fusing control method comprising:
sensing whether a skew of a paper is generated, wherein the skew refers to the paper being obliquely fed along a paper feeding path; and
turning off fusing operations of a fusing unit, which fuses a developer transferred on the paper, if the skew is sensed.

11. The method as claimed in claim 10, further comprising turning off a heater lamp, which is provided in a fusing roller of the fusing unit to heat the fusing roller, and accordingly, turning off fusing operations of the fusing unit, if the skew is sensed.

12. The method as claimed in claim 10, further comprising preventing an LSU, which emits a laser beam on a photosensitive medium to form an electrostatic latent image, from forming an electrostatic latent image on a surface of the photosensitive medium if the skew is sensed.

13. The method as claimed in claim 10, further comprising:
detecting a voltage of the transfer unit, which transfers an image developed by the developer onto the paper;
determining whether the detected voltage of the transfer unit falls within a predetermined reference voltage range of the transfer unit; and
outputting a detection result signal according to a determination result, wherein the heater lamp is turned off, and accordingly, the fusing operations of the fusing unit are turned off, if the detection result signal indicates that the voltage is abnormal.

14. The method as claimed in claim 13, further comprising:
determining that the voltage of the transfer unit is abnormal if the voltage of the transfer unit does not fall within the predetermined reference voltage range of the transfer unit; and
determining that the voltage of the transfer unit is normal if the voltage of the transfer unit does not fall within the predetermined reference voltage range of the transfer unit.

15. The method as claimed in claim 13, further comprising:
calculating a fusing time required to pass the paper from an entrance side to an exit side of the fusing unit, wherein, if the detection result signal indicates that the detected voltage falls within the predetermined reference range, comparing a predetermined reference fusing time with the calculated fusing time, and if the calculated fusing time is greater than the predetermined reference fusing time, transmitting a message or warning to a user indicating that a temperature of the fusing unit needs to be checked.

16. The method as claimed in claim 15, wherein the reference fusing time refers to a time required to pass the paper from the entrance side to the exit side of the fusing unit, and is pre-set depending on product models of the image forming apparatus.

17. The method as claimed in claim 13, further comprising the operation of turning off the heater lamp which heats the fusing roller, and accordingly, turning off the fusing operations of the fusing unit, if the detection result signal indicates that the detected voltage is abnormal.

18. The method as claimed in claim 10, further comprising:
calculating a fusing time required to pass the paper from an entrance side to an exit side of the fusing unit;
transmitting the calculated fusing time; and
comparing the calculated fusing time with a predetermined reference fusing time, wherein, if the calculated fusing time is greater than the reference fusing time, a controller transmits a message or a warning LED to a user indicating that a temperature of the fusing unit needs to be checked.

19. An image forming apparatus comprising:
a fusing unit which fuses developer transferred onto a recording medium using a heating source which is powered from a power supply; and
a controller which adjusts power supplied to the heating source in order to prevent developer and power from being used on the recording medium when the recording medium is obliquely fed onto the paper feeding path.

20. The image forming apparatus of claim 19, wherein the heating source is a halogen lamp which emits heat by alternating current electricity.

21. The image forming apparatus of claim 20, further comprising a sensor which senses whether a skew of a paper is generated, wherein the skew refers to the paper being obliquely fed along a paper feeding path.

22. The image forming apparatus of claim 21, further comprising:
a transfer unit which transfers an image developed by the developer onto the paper; and
a detector which detects a voltage of the transfer unit and determines whether the detected voltage of the transfer unit falls within a predetermined reference voltage range of the transfer unit, wherein the controller turns off the heater lamp if a detection result signal received from the detector indicates that the detected voltage does not fall within the predetermined reference voltage range.

23. The image forming apparatus as claimed in claim 22, further comprising:
a fusing unit sensor which calculates a fusing time required to pass the paper from an entrance side to an exit side of the fusing unit and transmits the calculated fusing time to the controller, wherein, if the detection result signal received from the detector indicates that the voltage of the transfer unit falls within the predetermined reference voltage range, the controller compares a predetermined reference fusing time with the fusing time received from the fusing unit sensor, and if the fusing time received from the fusing unit sensor is greater than the reference fusing time, the controller transmits a message or a warning LED to a user indicating that a temperature of the fusing unit needs to be checked.

24. The image forming apparatus as claimed in claim 23, wherein the reference fusing time refers to a time required to pass the paper from the entrance side to the exit side of the fusing unit, and is pre-set depending on product models of the image forming apparatus.

25. The image forming apparatus as claimed in claim 24, wherein if the detection result signal received from the detector indicates that the voltage falls within the predetermined reference voltage range, the controller turns off the heater lamp, and accordingly, turns off the fusing operations of the fusing unit.

26. The image forming apparatus as claimed in claim 25, wherein the controller compares a number of papers sensed by the fusing unit sensor with a number of papers requested by a user, and if the number of papers sensed by the fusing unit sensor matches the number of papers requested by a user, the controller completes printing work.
